(19) United States
(12) Patent Application Publication
(10) Pub. No.: US 2007/0121439 A1
(43) Pub. Date: May 31, 2007

(54) Optical disc drive and method for controlling the position of a lens

(75) Inventor: Antonius Leonardus Johannes Dekker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/574,364

(22) PCT Filed: Oct. 5, 2004
(86) PCT No.: PCT/IB04/51966

§ 371 Date: Mar. 30, 2006

(30) Foreign Application Priority Data
Oct. 6, 2003 (EP) 03103683.3

(51) Int. Cl. G11B 7/00

(52) U.S. Cl. 369/44.28; 369/44.29

(57) ABSTRACT

An optical disc drive having a lens position motor (24) for control of a lens position relative to a track on a disc (10) and a second (“sledge”) motor (25) for control of the position of the first motor and of the lens radially relative to the disc. An alternating signal is generated (56) and applied to the lens position motor to modulate the control of the lens position motor. In this manner, the control loop that controls the lens position motor can have higher bandwidth and therefore greater responsiveness during rough searching or at initialization. For example, where the control circuit controlling the first motor has a lowpass filter (65) with a cut-off frequency, this cut-off frequency can be selected relative to the frequency of the alternating signal.

This invention relates to an optical disc drive comprising:

a lens for focusing and positioning a radiation beam on an optical disc,

wherein the radiation beam is reflected by the optical disc;

means for causing the optical disc to rotate with a disc rotational frequency, and

detection means for receiving the reflected radiation beam and generating a radial error signal indicating a position of the lens relative to the optical disc,

lens position motor for moving the lens,

a servo control circuit having a tracking mode for controlling the position of the lens in response to the radial error signal, comprising a first motor control circuit for controlling the lens position motor.

The invention also relates to a method for controlling the position of a lens in an optical disc drive, the method comprising the steps of:

causing an optical disc to rotate with a disc rotational frequency;

controlling the position of the lens with a lens position motor.

It is typical in an optical disc drive to provide an optical head for recording and reading information in the track of a rotating optical disc, with a lens actuator provided on the optical head for displacing a light spot in a direction traversing the track of the optical disc. Such an arrangement is described in U.S. Pat. No. 6,163,513. Such an optical disc drive typically consists of a radial lens position motor and an axial lens position motor for controlling the lens that positions the laser spot in radial and axial directions. These motors are positioned on an unit that is positioned on a positioner (or “sledge”) that can be moved by a linear motor, or by a rotating motor and a transmission. In order to control the spot in a radial sense, control loops are required.

There is a need for short response times in the control loops that control the laser spot. For example, before the read-out of a disc, initialization has to be done once with the disc. Initialization determines a tracking offset value used in a track control loop. Also a radial lens position error may be determined during initialization to be used later during a rough search.

At initialization, there is a need to achieve tracking as quickly as possible. The time to achievement of tracking is determined in part by the bandwidth of the control loop that controls the offset of the radial error signal. The optical disc is typically not perfectly centered and eccentricity of the disc gives rise to frequency modulated signals in this control loop. These are typically filtered out using a low pass filter, but this in turn reduces the bandwidth of the control loop and, therefore, its responsiveness.

Furthermore, during non-tracking situations, the sledge can be controlled to perform a rough search. During a rough search the sledge causes the lens to jump radially over the disc while the actuator is controlled to maintain a central position in respect to the sledge. Although the number of tracks passed during such a jump can be counted in order to evaluated more precisely the radial position, typically this kind of jump is effectuated without counting of the tracks. The jump is therefore approximate (rough) and needs a correction jump after the position is evaluated by data reading. Again, the bandwidth of the control loop that controls the sledge limits the time to completion of a rough search.

There is a need to improve the response time of control circuits for optical disc drives.

According to a first aspect of the present invention, the optical disc drive control circuit is provided with means for applying an alternating signal to the lens position motor.

The method according to the invention further comprises a step of applying an alternating signal to the lens position motor.

By applying the alternating signal to the lens position motor the control of the lens position motor is modulated. Consequently, the control loop that controls the lens position motor can have higher bandwidth and therefore greater responsiveness. For example, where the first motor control circuit has a low-pass filter with a cut-off frequency, this cut-off frequency can be selected relative to the frequency of the alternating signal.

The alternating signal preferably has a frequency higher than the disc rotational frequency, and an amplitude sufficient to cause the lens to shake with an amplitude of at least about 0.8 to 1.0 times the track pitch, for instance 0.88 times. By employing a radial offset control feedback loop with a time constant that is low in relation to the rotational frequency of the disc, faster offset determination is achieved with a correspondingly shorter start-up time.

In an embodiment of the optical disc drive the optical disc drive further comprises

a sledge for moving the lens position motor and the lens in radial direction relative to the optical disc, and

a second motor for control of the sledge,

wherein the servo control circuit comprises a second motor control circuit for controlling the second motor.

The first motor control circuit preferably has means for detecting the position of the lens relative to a sledge, and providing a lens position feedback signal which is combined with the alternating signal to give a modulated signal to the lens position motor.

In a favorable embodiment of the optical disc drive according to the invention the lens position signal is fed to a low-pass filter with a cut-off frequency less than the frequency of the alternating signal and an output of the low-pass filter is fed to the lens position controller.

The low pass filter can have a higher cut-off frequency allowing higher control bandwidth because of the raised frequency contents of the position signal due to the alternating signal.

In a further embodiment of the optical disc drive according to the invention the servo control circuit comprises a radial offset control feedback loop. The radial offset control feedback loop can be implemented by either measuring a lens position offset in the case where a lens position signal is available or measuring a radial offset in the radial error signal itself.

In an embodiment of the invention the radial offset control feedback loop is able to operate in a first mode and in a second mode, wherein in the first mode the lens is moved in a neutral position and a lens position offset in the lens position signal is measured and in the second mode the lens position signal is corrected with the measured lens position offset.

In an other embodiment of the invention a radial offset of the radial error signal is measured and subtracted from the radial error signal.

By applying the alternating signal to the radial to the lens position motor during initialization of the radial offset feedback loop, the initialization process can be performed more quickly.

Preferred embodiments of the invention are now described, by way of example only, with reference to the drawings, in which

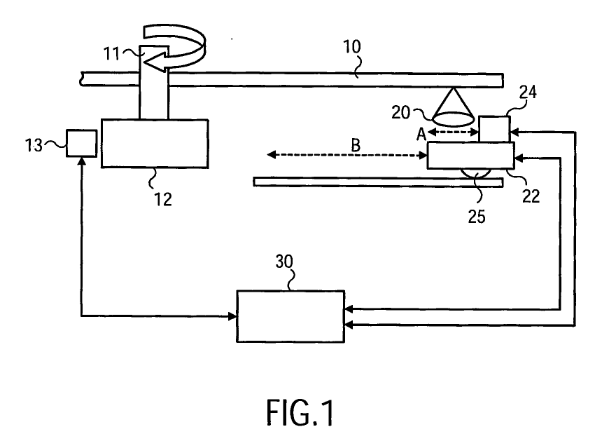

FIG. 1 shows an optical disc reader in accordance with an aspect of the present invention, incorporating a control circuit also in accordance with the present invention,

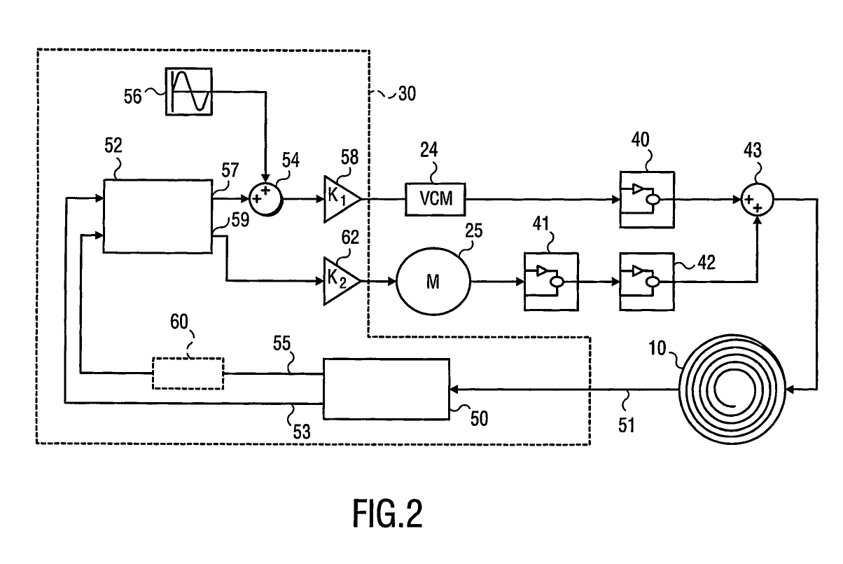

FIG. 2 shows an embodiment of a control circuit in accordance with the present invention,

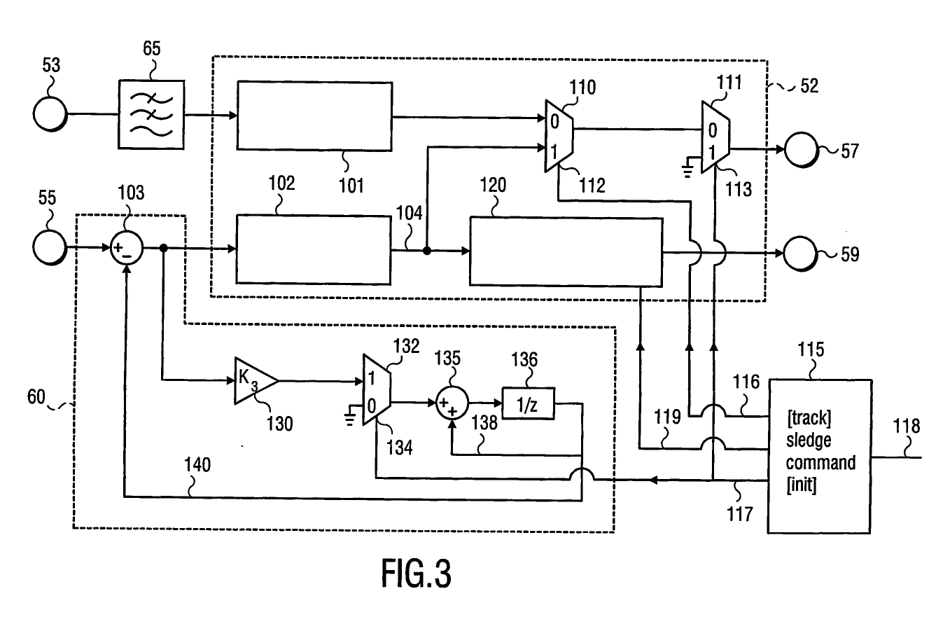

FIG. 3 shows optional details of the control circuit of FIG. 2,

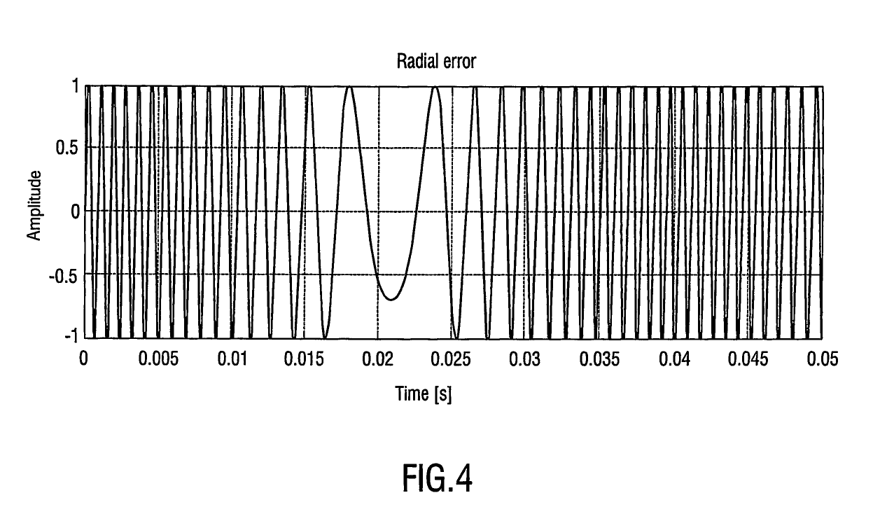

FIG. 4 shows a plot of the radial error signal, and

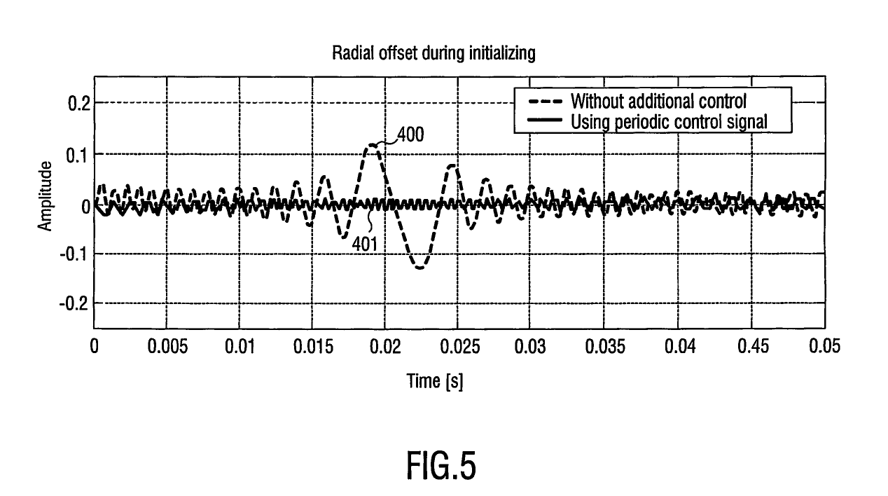

FIG. 5 is a continuation of FIG. 4 showing the radial offset during initializing.

Referring to FIG. 1, an optical disc drive of an optical disc reader is shown for reading an optical disc. An optical disc 10 is shown side-on, mounted on a spindle 11 of a disc motor 12. Associated with the disc motor 12 is a disc rotational speed controller 13. Beneath the disc 10 is a lens 20 that controls a beam of a laser (not shown). The lens 20 is mounted on a sledge 22, driven by a sledge motor 25. A voice coil motor (VCM) 24 controls the position of the lens 20 relative to the sledge 22. A control circuit 30 controls the motor 12, the sledge motor of the sledge 22 and the VCM 24. The control circuit 30 also receives feedback signals from these respective elements.

In operation, the motor 12 causes the disc 10 to rotate at a predetermined rotational frequency. The motor control circuit 13 controls the steady rotation of the disc 10. The lens 20 focuses the laser onto a track on the underside of the disc 10. The VCM 24 controls the position of the lens 22 relative to the track in the direction of arrow A. Sledge 22 moves the lens 20 and its associated VCM 24 radially in relation to the disc 10 along the direction of the arrow B.

Referring to FIG. 2, the control circuit 30 is shown in dotted outline and is shown connected to the VCM 24 and the sledge motor 25. To the right of these motors are illustrated an actuator 40, a sledge motor transmission element 41 and a sledge 42. These are not physical elements, but represent the control response functions of the VCM 24, the sledge motor 25 and the sledge 22, respectively. Combining function 43 is shown connected to elements 40 and 42, illustrating the combined response of those elements. The combined response from summer 43 represents the performance of the disc 10, which is fed back to a pre-processor 50 of the control circuit 30.

Within the control circuit 30, there are two control loops, a first for controlling the VCM comprises the pre-processor 50, a radial controller 52, a mixer element 54 receiving a signal from a signal injector 56 and a first gain element 58. The second control loop for controlling the sledge comprises the pre-processor 50, an optional radial offset control loop 60, the radial controller 52 and a second gain element 62. The radial offset control loop 60 can also be implemented in the first control loop. When the radial offset control loop 60 is implemented in the second control loop the radial offset of the radial error signal 55 is measured, and subsequently subtracted from the radial error signal. When the radial offset control loop 60 is implemented in the first control loop the lens position offset is measured, and subsequently subtracted from the lens position error signal 53.

In operation, the pre-processor 50 receives a signal 51 from an optical detector (not shown) associated with the disc 10 and its disc drive. The pre-processor 50 creates a lens position error signal 53 and a radial error signal 55. These signals are passed to the radial controller 52. The radial controller 52 has an actuator control output 57 passing an actuator control signal to the mixer 54 and a sledge control output 59 passing a sledge control signal to the sledge driver 62. As will be described in greater detail, a periodic signal is injected by signal injector 56 into mixer 54. In operation, the output of the sledge driver 62 drives the sledge motor 25 and the output of the actuator driver 58 drives the VCM 24. The resulting movement of these motors, as represented by elements 40 to 43, results in a change to the signal 51 read by the optical detector and, accordingly, the control loop is closed.

The control loops are disturbed by track cross modulation when the radial control is not tracking (while focused). This track cross modulation signal finds its origin in the radial error signal 55. This is a periodic signal. When there is no tracking, the laser beam crosses tracks, depending on the eccentricity of the disc 10. This results in a frequency modulated sinusoidal signal. The number of sine waves passed per disc rotation depends on the eccentricity, and the rate of modulation depends on the disc speed.

The VCM 24 moves the lens 20 that controls the laser beam position on the optical disc 10. The sledge 22, driven by motor 25 positions the VCM 24 and its lens in such a way that the lens is in its middle position. In order to jump to another track on the disc, the lens might have to make a large excursion. In that case, the sledge 22 moves the VCM 24 to another position along arrow B in FIG. 1. The lens 20 must remain in a middle position during such movement and must resist against the acceleration force exerted by the sledge. The lens position error signal 53 indicates the relative position of the lens with respect to the sledge. This is derived from the optical detector (not shown). The lens position feedback loop keeps the lens in the middle position. The lens position error signal 53 has track cross modulation which disturbs the lens position control. This track cross modulation component is reduced by a low pass filter 65 in or associated with the radial controller 52.

The cut off frequency of the low pass filter 65 in or associated with the radial controller 52 has to be low in order to have sufficient reduction of the track cross modulation. There is a relationship between maximum control bandwidth of the position control and the filter cut off frequency, because of the stability of the control. A low cut off frequency of the low pass filter of the radial controller 52 gives the control loop a low control bandwidth and, accordingly, a poor reduction of disturbances that arise from the moving sledge.

A periodic signal is generated in signal generator 56 and applied to the actuator control signal 57, such that when amplified by actuator driver 58, its effect on the VCM gives an amplitude of movement of about 0.88 times the track pitch. The frequency of the signal is higher, and preferably substantially higher, than the disc revolution frequency. The preferred frequency of the alternating signal is 2 kHz. This is suitable for disc speeds from 3 to 160 rotations per second. In this way, the frequency modulation in the lens position detector signal becomes high frequency. A cut-off frequency close to the alternating signal frequency, but below this frequency, can be chosen for the filter 65. The preferred cut-off frequency of the low pass filter in the lens (actuator) position loop is about 1 kHz. This is a higher cut-off frequency than has previously been possible and, because of this, the controlled bandwidth of the lens position loop can be higher. This results in better tracking performance of the lens with respect to the sledge.

Referring to FIG. 3, the radial controller 52 is shown in phantom outline for the purposes of illustrating detail thereof. Connected between the radial error signal 55 from the pre-processor 50 and the radial controller 52 is the radial offset controller 60 (which has been described as optional in relation to FIG. 2).

The radial controller 52 comprises a lens position controller 101 coupled to the input to the lens position error signal 53. A track controller 102 is provided coupled to the input of the radial error signal 55 via a difference element 103. Connected between the lens position controller 101 and the lens position control signal output 57 are a first multiplexer (switch) 110 and a second multiplexer (switch) 111. The first multiplexer 110 receives the lens position control signal from the lens position controller 101 at its upper (negative) input and receives a tracking control signal 104 from the track controller 102 on its lower input. It also has an switch input 112, which causes the multiplexer to pass its upper input to its output when high and its lower input to its output when low. The second multiplexer 111 receives the output of the first multiplexer 110 at its upper input and has its lower input grounded. The second multiplexer 111 has a switch input 113 also causing it to pass its upper input to its output when high and its lower input to its output when low.

A supervisor micro-controller 115 is provided with a track control output 116 connected to the switch input 112 of the first multiplexer 110 and an initialize output 117 connected to the switch input 113 of the second multiplexer 111. The supervisor micro-controller 115 has a communication channel 118 for receiving control commands from a user.

Connected between the track controller 102 and the sledge control signal output 59 is a sledge controller 120, the input of which is a radial control input and the output of which is a sledge control output.

The track controller 102 is effective when the laser spot has to read out data on the disc. The track controller 102 receives an input signal (via pre-processor 50) from a photo diode detector (not shown) that detects the tracking error between the laser spot and the disc track to be read. A tracking offset value, determined in an initialization controller (in micro-controller 115), is subtracted from the tracking error signal. (Initialization is described in greater detail below.)

The offset reduced tracking error signal (output from difference element 103) is the input for the lens track controller 102 that controls the radial position of the lens. The task of the this controller is to reduce the tracking error to an acceptable limit. The track controller 102 provides control to the positioner (sledge 42) under control of a positioner controller in the micro-processor 115, so that the track control signal 104 is passed to the radial lens position motor (VCM 24). The task of the positioner controller is to keep the positioner (sledge 42) in a neutral position in respect to the lens, which is realized by keeping the control signal 57 of the radial lens position motor (VCM 24) within predefined limits using feedback control. The measure by which the controller reacts to an error at its input depends on its gain. Higher gain and higher control bandwidth results in faster reaction. The controller gain (together with the characteristics of the motors) limits the error. The controller gain is not constant over the frequency band but has a frequency compensator, as is known in the art, to keep the system stable.

Referring now to the radial offset controller 60, this comprises a gain element 130 having a third gain value (an offset learning gain) k₃, connected to the upper input of a third multiplexer (switch) 132. The third multiplexer 132 has its lower input grounded. The third multiplexer 132 has a switch input 134 causing it to pass its upper input to its output when high and its lower input to its output when low. The output of the third comparator 132 is connected via a summer 135 to a delay element 136 having a delay 1/z. At an output of the delay element 136, there is a feedback loop 138 feeding back to the summer 135. Also at the output of the delay element 136 is a feedback loop 140 feeding back to a negative input of the difference element 103.

The initialize output of the supervisor micro-controller 115 is a logical signal which, when true, causes the radial error offset control to switch on by causing the third multiplexer 132 to pass its upper input to its output, thereby closing the radial offset control loop. It also ceases control of the VCM (and hence the actuator) by causing the second multiplexer 111 to switch its grounded lower input to its output. This signal is temporarily true when a disc is started up.

When a disc is started up, initialization needs to be carried out. For this purpose an initialization controller within micro-controller 115 is provided. This initialization controller is in action during some time before the first reading of a disc in order to determine the tracking offset value used in the track control loop. Also a radial lens position error is determined which is used in the lens position controller 101 during a rough search.

The initialization loop contains the same parts as mentioned above, but the radial lens position motor (VCM 24) is not controlled. The control loop reduces the mean value of the radial error by subtracting an offset signal. This tracking offset signal is kept in a register in microcontroller 115 as the tracking offset value and is available in the track controller 102. In the same way a control loop may reduce the mean value of the lens position error signal 53. The radial lens position motor is not controlled whilst the axial lens position motor keeps the lens in focus. In this situation the tracking error signal (FIG. 4, described below) is a frequency modulated signal. Each time when a track passes under the laser spot a wave form indicating the tracking error is detected and the frequency of wave forms that passes depends on the number of tracks per second that pass under the laser spot. The initialization loop is perturbated by this frequency modulated component of the tracking error and this limits the speed at which this loop can find an acceptable tracking offset value.

One aspect of the invention concerns shaking the lens in radial sense in this loop by applying a sine signal to the radial lens position motor (VCM 24). In this way the spot will always pass the tracks with a relatively high frequency. Therefore offset iterations can be done quicker and the drive can proceed by tracking the disc earlier.

The initialize output of the supervisor micro-controller 115 may also be true at the entrance of a new zone on the disc. The controller may divide the disc into several zones for this purpose.

After an initialization period, the initialize signal becomes false causing the offset of the radial error signal to be removed, and the lens position control begins.

After initialization, when a rough search is required and the sledge is required to move from one position to another, the micro-controller 115 provides a “false” signal on its track control output 116. This causes the actuator to be positioned in its neutral position. During rough searching, the lens controller 101 (rather than controller 102) controls the VCM. The sledge controller 120 performs a rough search upon receipt of a command 119 from the micro-controller 115. During the rough search, the sledge is controlled independently from other aspects of the radial controller 52. In this situation the VCM (the actuator) is switched to the lens position controller 101.

The rough search loop is effective when the laser spot has to jump to another radial position on the disc that is not sufficiently near that the jump can be effectuated by the lens alone. In this case the positioner (actuator 40) is displaced by the positioner controller (lens position controller 101).

A rough search controller is provided (not explicitly shown, but embodied in the micro-controller 115 and the sledge controller 120) which receives a signal (via pre-processor 50) from a photo diode detector (not shown) that detects the lens position in respect to the positioner (the sledge). This is the lens position error signal 53. The rough search controller also uses lens position controller 101 to reduce this lens position error signal to an acceptable level.

A lens position error offset value, determined in the initialization loop (described above), is subtracted from the lens position error signal 53. The lens position error signal 53 can have a relatively high cross talk from the radial error. Therefore the same frequency modulated signal can perturbate this lens position control loop. To reduce this perturbation the lens position loop contains a low pass filter 65. This low pass filter limits the bandwidth of the loop and therefore the responsiveness of the loop.

Another aspect of the invention concerns shaking the lens in a radial sense in this loop by adding a sine signal from signal generator 56 to the radial lens position motor. In this way the spot will always pass the tracks with a relatively high frequency. Therefore the cut-off frequency of the low pass filter 65 can be increased and by that also the band width of the control. This results in better responsiveness and reduces the lens lag during fast positioner displacements.

During tracking operation the actuator is controlled in respect to the track of the disc and the sledge is controlled to stay in a neutral position in respect to the lens (using the lens control signal 104), but during rough searching the actuator is controlled (by lens position controller 101) to maintain a central position in respect to the sledge. During tracking the lens is master, while during rough search the sledge is master.

The task of the controller 115 is to configure the controllers by putting them in right operation modes. The sledge controller 120 is able to control the sledge during a rough search. To do this it receives a command from micro-controller 115. In this situation, shaking of the actuator control signal by means of signal generator 56 causes the low frequency components of the lens position error signal 53 to be reduced and allows the control bandwidth to be increased. This in turn reduces the time taken to perform a rough search.

When the laser beam is required to follow a track, the micro-controller 115 provides a “true” signal on output 116, whereupon the first multiplexer 110 causes the lens position control signal from lens position controller 101 to be passed to the second multiplexer 111, which is now switched to receive its upper input, thereby passing it to the VCM 24 (and the actuator 40).

The radial offset control 60 is used during tracking only, and the offset itself is evaluated during the initialization operation.

Thus, the lens 20 is controlled in its radial position by feedback control using the radial error signal 55 generated in the photodetector. When radial control is switched off, offset is removed from the signal by offset feedback control using the radial offset controller 60 and the radial error signal is now a frequency modulated signal, depending on the eccentricity of the disc 10.

When the eccentricity is low and the speed is low, the frequency of the track crossing signal is low and the offset controller tends to follow the slow signal trend. The bandwidth of this control needs to be low in order to determine the offset with sufficient accuracy. By applying a periodic signal from signal generator 56 to the VCM 26 with an amplitude of about 0.8 to 1.0 times (and preferably about 0.88 times) the track pitch and a frequency significantly or substantially higher than the disc revolution frequency, the modulation in the lens position error signal 53 becomes high frequency. Accordingly, the time constant of delay element 136 can be chosen at a lower value than would otherwise be possible. A preferred value for this time constant is about 25 ms. This results in a faster offset determination and shorter start-up time for the optical disc reader.

Referring now to FIGS. 4 and 5, the improvement provided by the features of the invention is illustrated by showing the radial error and the radial offset for an optical disc drive during initialization, with and without application of the alternating signal to the VCM that moves the lens. The figures show the response of the system at different times following start-up. Curve 400 of FIG. 5 represents the lens focus without radial shaking of the lens. As can be seen, there is a significant departure from focus shortly after initialization and the focus settles down only after about 0.03 seconds. By contrast, curve 401 shows the focus offset using the periodic control signal from the signal generator 56 and here it is seen that there is no significant loss of focus from the very start of initialization. FIG. 4 shows the corresponding radial error signals 55, ranging from a maximum of 1 to a minimum of −1 and it can be seen that the radial error signal has high frequency below about 0.015 seconds and the frequency of the error drops at around about 0.02 seconds, rising again after about 0.025 seconds.

Accordingly, a control circuit for an optical disc reader, and an optical disc reader having such a control circuit, have been described in which the lens radial actuator, for example a VCM, is modulated in a radial direction using a alternating signal while it is not tracking. This increases the minimal track crossing frequency. By increasing the minimal track crossing frequency, track cross modulation components, particularly in the lens position control loop, can be decreased using low pass filtering at an increased cut off frequency. This reduces the startup time and increases control accuracy in control of the lens position.

Further modifications of the invention can be made by one of ordinary skill in the art within the scope of the invention and further advantages of the invention will be apparent. A single processor or unit may fulfill the functions of several means recited in the claims. A single means recited may be fulfilled by several independent means. Where an element or step is described as comprising one or more elements or steps, the term “comprising” does not exclude other elements or steps. The indefinite article “a” or “an” does not exclude a plurality.

1. An optical disc drive comprising:
a lens (20) for focusing and positioning a radiation beam on an optical disc (10), wherein the radiation beam is reflected by the optical disc;
means (12, 13) for causing the optical disc (10) to rotate with a disc rotational frequency, and
detection means for receiving the reflected radiation beam and generating a radial error signal (55) indicating a position of the lens (20) relative to the optical disc (10),
lens position motor (24) for moving the lens (20),
a servo control circuit (30) having a tracking mode for controlling the position of the lens (20) in response to the radial error signal (55), comprising a first motor control circuit (52, 58) for controlling the lens position motor (24),
characterized in that the control circuit (30) further comprises means (54, 56) for applying an alternating signal to the lens position motor (24).

2. An optical disc drive according to claim 1, wherein the alternating signal has a frequency higher than the disc rotational frequency.

3. An optical disc drive according to claim 1, for an optical disc (10) having a given track pitch, wherein the alternating signal is of an amplitude sufficient to cause the lens (20) to shake with an amplitude of at least about 0.8 to 1.0 times the track pitch.

4. An optical disc drive according to claim 1, further comprising
a sledge (22) for moving the lens position motor (24) and the lens (20) in radial direction relative to the optical disc (10), and
a second motor (25) for control of the sledge (22), wherein the servo control circuit (30) comprises a second motor control circuit (52, 62) for controlling the second motor (25).

5. An optical disc drive according to claim 4, wherein the detection means are adopted to generate a lens position signal (53) which is indicative of the position of the lens (20) with respect to the sledge (22).

6. An optical disc drive according to claim 5 wherein the servo control unit (30) has a non-tracking mode and wherein the servo control unit (30) further comprises a lens position controller (101) for outputting a lens position control signal (57) to control the position of the lens (20) in response to the lens position signal (53) in the non-tracking mode.

7. An optical disc drive according to claim 6, wherein the lens position signal (53) is fed to a low-pass filter (65) with a cut-off frequency less than the frequency of the alternating signal and an output of the low-pass filter (65) is fed to the lens position controller (101).

8. An optical disc drive according to claim 6, wherein the servo control circuit (30) further comprises means (54) for combining the lens position control signal (57) with the alternating signal to give a modulated signal to the lens position motor (24).

9. An optical disc drive according to claim 1 wherein the servo control circuit (30) comprises a radial offset control feedback loop (60).

10. An optical disc drive according to claim 9, wherein the radial offset control feedback loop (60) is able to operate in a first mode and in a second mode, wherein in the first mode the lens (20) is moved in a neutral position and a lens position offset in the lens position signal (53) is measured and in the second mode the lens position signal (53) is corrected with the measured lens position offset.

11. An optical disc drive according to claim 10, further comprising a micro-controller (115) receiving an input from a user and providing an initialization signal (117) in response to the user input, wherein:
first switching means (111) responsive to the initialization signal (117) are provided for selectively causing the lens position motor (24) to allow the lens position to adopt a neutral position or cause the lens position motor (24) to be controlled by the first motor control circuit, and
the radial offset control feedback loop (60) comprises second switching means responsive to the initialization signal (117) for selectively measuring a lens position offset of the lens position signal (53) or correcting the lens position signal (53) with the measured lens position offset.

12. An optical disc drive according to claim 9, wherein the radial offset control feedback loop (60) is able to operate in a first mode and in a second mode, wherein in the first mode the lens (20) is moved in a neutral position and wherein a radial offset in the radial error signal (55) is measured and wherein in the second mode the measured radial offset is subtracted from the radial error signal (55).

13. An optical disc drive according to claim 12, further comprising a micro-controller (115) receiving an input from a user and providing an initialization signal (117) in response to the user input, wherein:
first switching means (111) responsive to the initialization signal (117) are provided for selectively causing the lens position motor (24) to allow the lens position to adopt a neutral position or cause the lens position motor (24) to be controlled by the first motor control circuit, and
the radial offset control feedback loop (60) comprises third switching means (132) responsive to the initialization signal (117) for selectively measuring a radial offset of the radial error signal (55) or correcting the radial error signal (55) with the measured radial offset.

14. An optical disc drive according to claim 9, wherein the radial offset control feedback loop (60) has a time constant that is low with respect to the disc rotational frequency.

15. Method for controlling the position of a lens (20) in an optical disc drive, the method comprising the steps of:
causing an optical disc (10) to rotate with a disc rotational frequency;
controlling the position of the (20) lens with a lens position motor (24);
characterized in that the method further comprises a step of applying an alternating signal to the lens position motor (24).
